(19) United States
(12) Patent Application Publication
(10) Pub. No.: US 2009/0215490 A1
(43) Pub. Date: Aug. 27, 2009

(54) METHODS FOR HANDLING PROACTIVE COMMANDS FOR ONE OR MORE SUBSCRIBER IDENTITY CARDS AND SYSTEMS UTILIZING THE SAME

(75) Inventors: Sheng Hua Lee, Taipei City (TW); Yu-Ju Lee, Taipei City (TW); Ching Sheng Chen, Taipei City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: MEDIATEK INC., Hsin-Chu (TW)

(21) Appl. No.: 12/269,911

(22) Filed: Nov. 13, 2008

Related U.S. Application Data
(60) Provisional application No. 61/031,769, filed on Feb. 27, 2008.

(51) Int. Cl. H04M 1/00

(52) U.S. Cl. 455/558

(57) ABSTRACT

A method for handling a proactive command in a mobile system with a subscriber identity card, executed by a micro-processing unit (MCU) of a Baseband chip, is provided. A response code is received from the subscriber identity card, wherein the response code indicates the mobile system to fetch the proactive command for a specific procedure. It is determined whether the mobile system is under a specific condition after receiving the response code. The response code is ignored until the specific condition is absent.

### CROSS REFERENCE TO RELATED APPLICATIONS

This application claims the benefit of U.S. Provisional Application No. 61/031,769, filed on Feb. 27, 2008, the entirety of which is incorporated by reference herein.

### BACKGROUND OF THE INVENTION

1. Field of the Invention

The invention relates to a method for handling proactive commands, and more particularly to a method for handling proactive commands in a mobile system with one or more subscriber identity cards.

2. Description of the Related Art

Currently, the Global System for Mobile communication (GSM) standard is the popular standard for mobile phones in the world. The GSM standard, standardized by the European Telecommunication Standards Institute (ETSI) is a cellular network structure and a Time Division Multiple Access (TDMA) system. For a carrier frequency, the TDMA system will divide a frame into eight time slots, wherein each time slot is used to transmit a channel data for a subscriber. In addition, the General Packet Radio Service (GPRS) technology is one of the available technologies of a GSM network. The GPRS technology utilizes the unused channels in the GSM network to provide moderate speed data transmission. The Wideband Code Division Multiple Access (W-CDMA) is a wideband spread-spectrum mobile air interface that utilizes the direct-sequence spread spectrum method of asynchronous code division multiple access to achieve higher speeds and support more users compared to the implementation of time division multiplexing (TDMA) used by 2G GSM networks. Time Division-Synchronous Code Division Multiple Access (TD-SCDMA) is another type of 3G mobile telecommunications standard.

A dual SIM mobile phone is a phone with two Subscriber Identity Modules (SIMs), which correspond to different telephone numbers. The dual SIM mobile phone allows a user to use two communication services without carrying two phones at the same time. For example, the same mobile phone may be used for business and private use with separate numbers and bills, thus providing convenience to mobile phone users.

For a conventional mobile phone or a dual SIM mobile phone, a proactive SIM gives a mechanism whereby the SIM can initiate actions to be taken by the mobile phone, i.e. each SIM is capable of issuing proactive commands to the mobile phone to perform tasks. For example, even if the mobile phone is busy, the mobile phone can still fetch the proactive command from the corresponding SIM card and then immediately send a “TERMINAL RESPONSE” with an error condition indicating that the mobile phone is currently unable to process the command. However, in such a case, because the mobile phone will repeatedly send the “TERMINAL RESPONSE” to the corresponding SIM card, power consumption of the mobile phone will continue. Thus, handling of proactive commands in a mobile phone with multiple SIM cards is important to reduce power consumption of mobile phones.

### BRIEF SUMMARY OF THE INVENTION

Methods for handling proactive commands for one or more subscriber identity cards and the mobile stations utilizing the same are provided. An exemplary embodiment of a method for handling a proactive command in a mobile system with a subscriber identity card, executed by a micro-processing unit (MCU) of a Baseband chip, is provided. A response code is received from the subscriber identity card, wherein the response code indicates the mobile system to fetch the proactive command for a specific procedure. It is determined whether the mobile system is under a specific condition after receiving the response code. The response code is ignored until the specific condition is absent.

Furthermore, an exemplary embodiment of a method for handling a first proactive command and a second proactive command in a mobile system with a first subscriber identity card and a second subscriber identity card is provided. A first response code is received from the first subscriber identity card. In response to the first response code, a command is issued to the first subscriber identity card to obtain a first proactive command, so as to perform a first procedure according to the first proactive command. A second response code is received from the second subscriber identity card. No response is made for the second response code when the first procedure is not completely preformed.

Moreover, an exemplary embodiment of a system comprises a subscriber identity card and a processor. The processor receives a first response code from the first subscriber identity card, wherein the first response code indicating the processor to fetch a first proactive command for performing a first procedure. The processor ignores the first response code when a specific condition is present. The processor issues a command to the first subscriber identity card to obtain the first proactive command and performs the first procedure according to the first proactive command when the specific condition is absent.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 shows a diagram illustrating applications in a form of an SAT/USAT applet, when executed by a SIM/USIM MCU, that request the mobile station to perform a particular task;

FIG. 2 shows a diagram illustrating an operation of a proactive command between the Baseband MCU and the SIM/USIM MCU;

FIG. 3A shows the hardware architecture of a mobile station according to an embodiment of the invention;

FIG. 3B shows the hardware architecture of a mobile station according to another embodiment of the invention;

FIG. 3C shows the hardware architecture of a mobile station according to another embodiment of the invention;

FIG. 4 shows a flow chart illustrating a method for handling an SAT/USAT application toolkit proactive command request according to an embodiment of the invention;

FIG. 5 shows a flow chart illustrating a method for handling an SAT/USAT proactive command request according to another embodiment of the invention;

FIG. 6 shows a flow chart illustrating an operation of a proactive command in a mobile station equipped with two subscriber identity cards according to an embodiment of the invention;

FIG. 7 shows a flow chart illustrating an operation of a proactive command in a mobile station equipped with two subscriber identity cards according to another embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

A subscriber identity module (SIM) card typically contains user account information, an international mobile subscriber identity (IMSI) and a set of SIM application toolkit (SAT) commands and provides storage space for phone book contacts. A micro-processing unit (MCU) of the Baseband chip (simply referred to as a Baseband MCU hereinafter) may interact with MCUs of the SIM cards (each simply referred to as a SIM MCU hereinafter) to fetch data or SAT commands from the plugged in SIM cards. A mobile station is immediately programmed after plugging in the SIM card. SIM cards may also be programmed to display custom menus for personalized services.

A universal SIM (USIM) card is inserted into a mobile station for universal mobile telecommunications system (UMTS) (also called 3G) telephony communication. The USIM card stores user account information, an IMSI, authentication information and a set of USIM Application Toolkit (USAT) commands and provides storage space for text messages and phone book contacts. A Baseband MCU may interact with an MCU of the USIM card (each simply referred to as a USIM MCU hereinafter) to fetch data or SAT commands from the plugged in USIM cards. The phone book on the USIM card is greatly enhanced when compared to the SIM card. For authentication purposes, the USIM card may store a long-term preshared secret key K, which is shared with the Authentication Center (AuC) in the network. The USIM MCU may verify a sequence number that must be within a range using a window mechanism to avoid replay attacks, and is in charge of generating the session keys CK and IK to be used in the confidentiality and integrity algorithms of the KASUMI (also termed A5/3) block cipher in the UMTS. A mobile station is immediately programmed after plugging in the USIM card.

A removable User Identity Module (R-UIM) or a Code Division Multiple Access (CDMA) Subscriber Identity Module (CSIM) card has been developed for a CDMA mobile station and is equivalent to the GSM SIM and 3G USIM except that it is capable of working in CDMA networks. The R-UIM or the CSIM card is physically compatible with the GSM SIM card, and provides similar security mechanisms for the CDMA system. The IMSI is a unique number associated with a global system for mobile communication (GSM) or a universal mobile telecommunications system (UMTS) network user. The IMSI may be sent by a mobile station to a GSM or UMTS network to acquire other details of the mobile user in the Home Location Register (HLR) or as locally copied in the Visitor Location Register (VLR). An IMSI is typically 15 digits long, but may be shorter (for example MTN South Africa's IMSIs are 14 digits). The first 3 digits are the Mobile Country Code (MCC), and they are followed by the Mobile Network Code (MNC), either 2 digits (European standard) or 3 digits (North American standard). The remaining digits are the mobile subscriber identification number (MSIN) for a GSM or UMTS network user.

A SIM application toolkit (SAT) is a standard of the GSM which enables an SIM MCU to initiate actions which can be used for various value added services. The SAT consists of a set of commands programmed into an SIM card which define how the SIM MCU interacts directly with the outside world and initiates commands independently of the mobile station and the network. The SAT enables the SIM MCU to build up an interactive exchange between a network application and an end user and access or control access to the network. The SIM MCU also provides SAT commands to the Baseband MCU to display a menu, ask for user input, or the similar. A SAT has been deployed by many network operators for many applications, often where a menu-based approach is required, such as Mobile Banking and content browsing. Designed as a single application environment, SAT can be started at the initial power up of the SIM card and is especially suited to low level applications with simple user interfaces.

A USIM Application Toolkit (USAT) is the equivalent of an SAT for 3G networks. A USAT enables the USIM MCU to initiate actions which can be used for various value added services delivered over the mobile station. The USAT is employed in a multi-application environment of 3G devices and is not activated until a specific application has been selected, unlike SAT, which is activated at startup. Certain functions are card related rather than application related.

SAT and USAT proactive commands may be grouped into two categories: RF-dependent; and RF-independent. RF-dependent SAT/USAT proactive commands, when executing by the Baseband MCU, requests RF resource (i.e. an RF module), while RF-independent SAT/USAT proactive commands do not request RF resource.

Exemplary RF-dependent SAT/USAT proactive commands are listed below.
SEND SHORT MESSAGE, which sends a short message or SMS-COMMAND to the network.
SEND SS, which sends a Supplementary Service (SS) request to the network.
SEND USSD, which sends an Unstructured Supplementary Service Data (USSD) string to the network.
SET UP CALL, of which there are three types:
   set up a call, but only if not currently busy on another call;
   set up a call, putting all other calls (if any) on hold;
   set up a call, disconnecting all other calls (if any).
SEND DTMF, which requests the mobile station to send Dual-Tone Multi-Frequency (DTMF) tone(s) during an established call.
LAUNCH BROWSER, which requests a browser inside a browser-enabled mobile station to interpret the content corresponding to a universal resource locator (URL).
OPEN CHANNEL, which requests the mobile station to open a data channel with parameters indicated in the command (if class “e” is supported.)
CLOSE CHANNEL, which requests the mobile station to close the specified data channel (if class “e” is supported).
RECEIVE DATA, which requests the mobile station to return to the subscriber identity data (e.g. SIM, USIM, R-UIM or CSIM data) received on the specified channel (if class “e” is supported).
SEND DATA, which requests the mobile station to send on the specified channel data provided by the subscriber identity card, such as SIM, USIM, R-UIM or CSIM card, (if class “e” is supported).
GET CHANNEL STATUS, which requests the mobile station to return the current status of all available data channel(s) (if class “e” is supported).

Exemplary RF-independent SAT/USAT proactive commands are listed below.
DISPLAY TEXT, which displays text or an icon on screen.
GET INKEY, which sends text or an icon to the display and requests a single character response in return.
GET INPUT, which sends text or an icon to the display and requests a response in return.
MORE TIME, which does not request any action from the mobile station, wherein the mobile station is required to respond with TERMINAL RESPONSE (OK) as normal.
PLAY TONE, which requests the mobile station to play a tone in its earpiece, ringer, or other appropriate loudspeaker.
POLL INTERVAL, which negotiates how often the mobile station sends STATUS commands to the SIM during the idle mode.
REFRESH, which requests the mobile station to carry out a subscriber identity (e.g. SIM, USIM, R-UIM or CSIM) initialization, and/or advises the mobile station that the contents or structure of EFs on the subscriber identity card have been changed. The command also makes it possible to restart a card session by resetting the subscriber identity card.
SET UP MENU, where the subscriber identity card supplies a list of items to be incorporated into the mobile station's menu structure.
SELECT ITEM, where the subscriber identity card supplies a list of items and a user is expected to choose one.
PROVIDE LOCAL INFORMATION, which requests the mobile station to pass local information to the subscriber identity card, for example the mobile country and network codes (MCC+MNC) of the network on which a user is registered.
SET UP EVENT LIST, where the subscriber identity card supplies a list of events, wherein the mobile station provides details of when the events have occurred.
TIMER MANAGEMENT, which requests the mobile station to manage a timer in a way described in the command (start, deactivate and get the current value) and, in the case of starting a timer, for a duration indicated in the command.
SETUP IDLE MODETEXT, which supplies a text string to be used by the mobile station as stand-by mode text.
RUN AT COMMAND, which conveys an AT Command to the mobile station, and causes the response to the AT Command to be returned to the subscriber identity card.
LANGUAGE NOTIFICATION, which allows the subscriber identity card to notify the mobile station about the language in text strings issued by the SAT/USAT application.

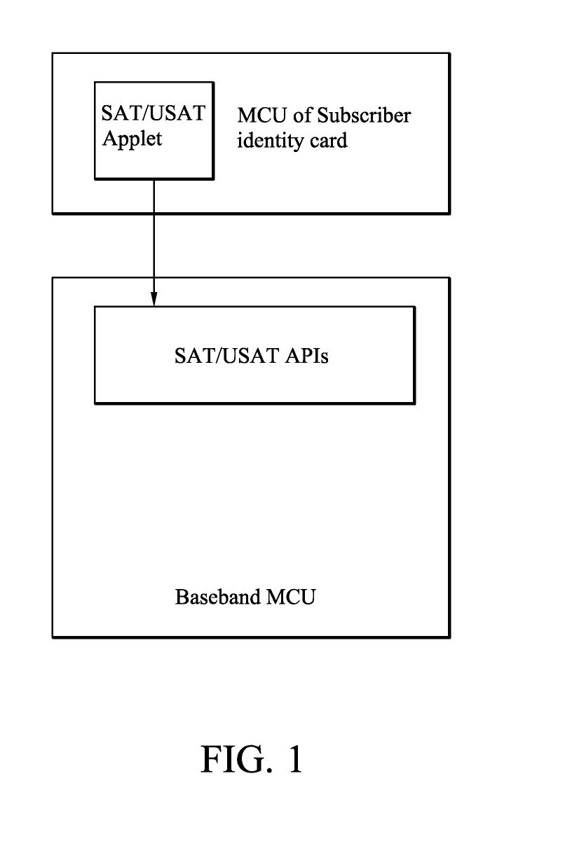

The SAT/USAT provides mechanisms which allow applications that are presented in a subscriber identity card to interact and operate with a mobile station which supports the specific mechanism(s) required by the applications. Specifically, referring to FIG. 1, applications in a form of an SAT/USAT applet, when executed by a MCU of a subscriber identity card, requests the mobile station (i.e. Baseband MCU/processor) to perform a particular task such as playing a tone, displaying text on a screen, getting user input, setting up a call, or others, by employing SAT/USAT application programming interfaces (API), also referred to as the mentioned SAT/USAT proactive commands. The subscriber identity card may be the mentioned SIM, USIM, R-UIM or CSIM card.

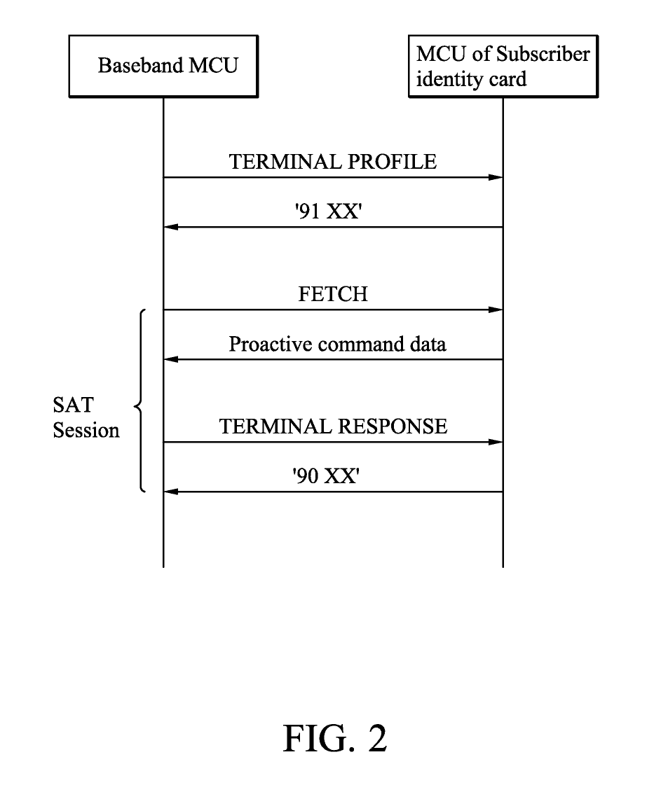

Referring to FIG. 2, the Baseband MCU operates as a master and initiates commands to the MCU of subscriber identity card. Note that SIM/USIM procedures may end in ‘90 00’ (indicating normal ending to the initiated command), or may end in ‘91 XX’ (indicating response data available from a subscriber identity card). The response code ‘91 XX’ may also inform the Baseband MCU that the previous command has been successfully executed by the MCU of subscriber identity card in the same way as ‘90 00’ (i.e. “OK”), as well as, indicate response data which contains an SAT/USAT proactive command from the MCU of subscriber identity card for a particular procedure. The value ‘XX’ indicates the length of the response data. After that, the Baseband MCU uses the FETCH command to obtain the response data indicating a particular SAT/USAT proactive command. If the indicated command has been successfully executed, the Baseband MCU informs the MCU of subscriber identity card of “TERMINAL RESPONSE”. If the indicated command is not successfully executed, the Baseband MCU informs the MCU of subscriber identity card of “TERMINAL RESPONSE” with an error condition.

When the RF module is busy, e.g. communicating with a corresponding node (CN), and the Baseband MCU fetches an RF-dependent SAT/USAT proactive command requesting for an RF resource to perform a particular operation, e.g. set up a call, send a short message and the similar, the Baseband MCU may respond to the MCU of subscriber identity card with “TERMINAL RESPONSE” and an error condition indicating that the RF resource is busy. When the RF module is occupied for a time interval, the Baseband MCU may repeatedly fetch the same SAT proactive command and respond with “TERMINAL RESPONSE” and the error condition. It is to be understood that unnecessary interactions between the Baseband and subscriber identity cards, however, yield more power consumption. Or, in some situations, such unnecessary interactions may cause the MCU of subscriber identity card fails if it cannot properly handle over certain runs of interactions.

Further, when a man-machine interface (MMI) of mobile station is occupied by one subscriber identity card and the Baseband MCU fetches a next SAT/USAT proactive command requesting for the MMI resource, the Baseband MCU may respond to the MCU of another subscriber identity card with “TERMINAL RESPONSE” and the error condition. The MMI may contain information on a display, such as at least one of a screen menu, an icons, a display message and the similar, and physical input devices such as at least one of a button, a key pad, a touch screen, a microphone and the similar. Specifically, for example, when a display of the mobile station displays information according to a proactive command from one MCU of subscriber identity card and waits for a corresponding response to be returned from an input device thereof (such as a keypad), the Baseband MCU fetches a SAT/USAT proactive command from another MCU of subscriber identity card, requesting for MMI resources to perform MMI-related operations, such as displaying text or short message on the display or others, the Baseband MCU may respond to another MCU of subscriber identity card with “TERMINAL RESPONSE” and the error condition to avoid the current MMI operations not to be interrupted.

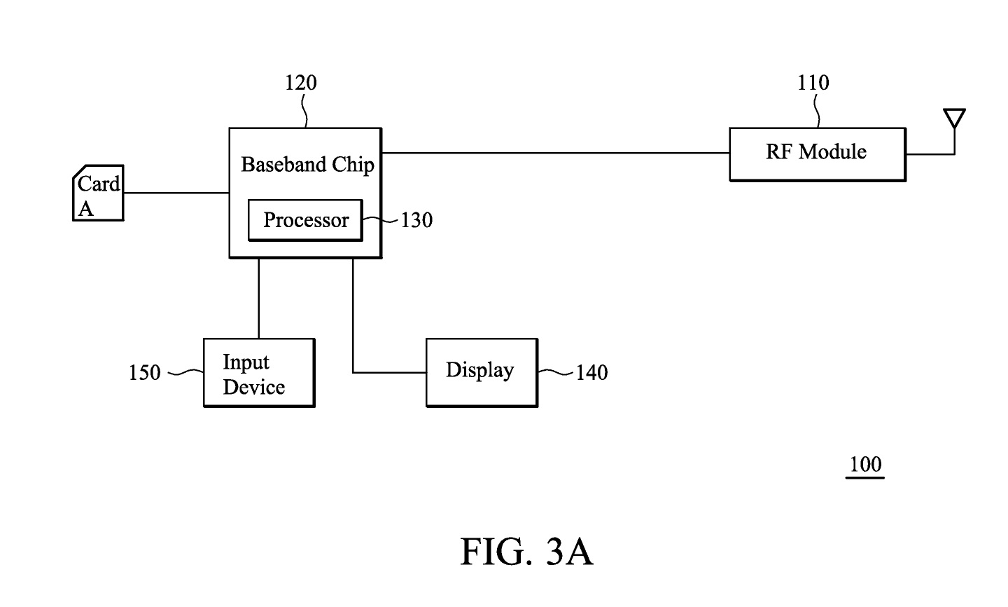

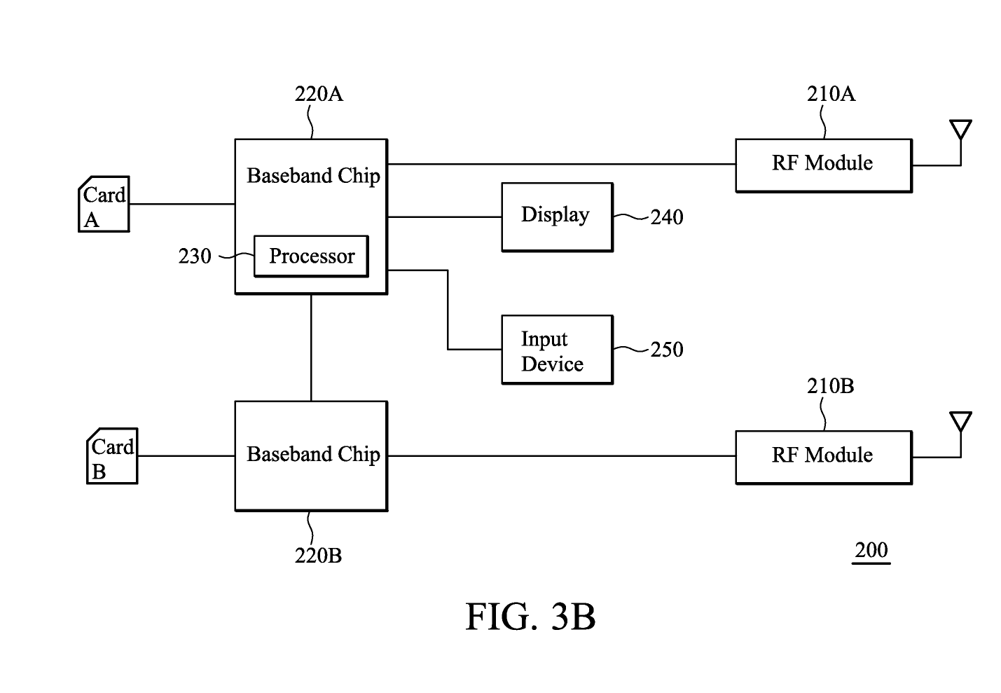

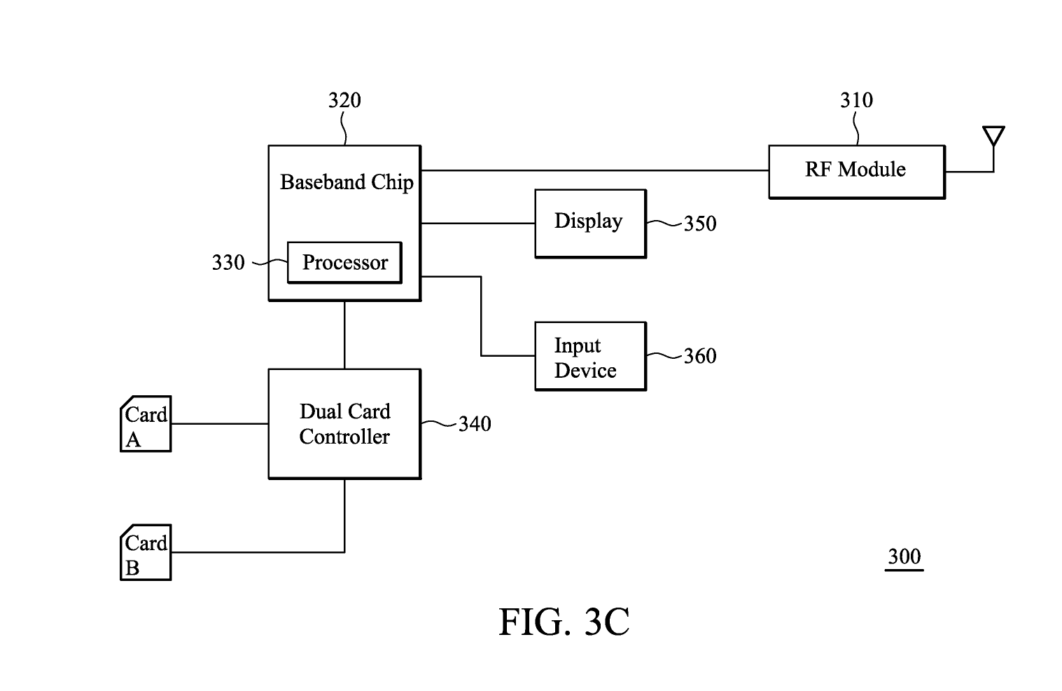

FIG. 3A shows the hardware architecture of a mobile station 100 according to an embodiment of the invention. The mobile station 100 comprises a radio frequency (RF) module 110, a Baseband chip 120, a display 140 and an input device 150, wherein the RF module 110, the display 140 and the input device 150 are coupled to the Baseband chip 120. A subscriber identity card A may be plugged into a socket of the mobile station 100 connecting to the Baseband chip 120. The subscriber identity card A may be a SIM, USIM, R-UIM or CSIM card, which is provided by a particular network operator. The Baseband chip 120 comprises a processor 130 for controlling the communications between the subscriber identity card A and the RF module 110, sending a series of frame data (e.g. representing text messages, graphics, images or others) to the display 140, and receiving signals from the input device 150.

FIG. 3B shows the hardware architecture of a mobile station 200 according to another embodiment of the invention. The mobile station 200 comprises two RF modules 210A and 210 B, two Baseband chips 220A and 220B, a display 240 and an input device 250, wherein the RF module 210A is coupled to the Baseband chip 220A and the RF module 210B is coupled to the Baseband chip 220B. The display 240 and the input device 250 are coupled to the Baseband chip 220A. Two subscriber identity cards A and B may be plugged into two sockets of the mobile station 200 connecting to the Baseband chips 220A and 220B, respectively. One of the subscriber identity cards A and B may be a SIM, USIM, R-UIM or CSIM card, which is provided by a particular network operator. The mobile station 200 can therefore simultaneously camp on two cells provided by either the same network operator or different network operators for the plugged in cards A and B and operate in stand-by/idle modes, or even dedicated modes, using different RF modules and Baseband chips. The Baseband chip 220A may read data from the subscriber identity card A and write data to the subscriber identity card A. The Baseband chip 220B may read data from the subscriber identity card B and write data to the subscriber identity card B. Furthermore, the Baseband chip 220A may be a master device for the mobile station 200, and the Baseband chip 220A comprises a processor 230 for controlling the communications between the Baseband chips 220A and 220B, handling MMI usage granting to the subscriber identity cards A and B, handling MMI-related operations (e.g. sending a series of frame data to the display 240, receiving signals from the input device 250, and so on), or others. A further processor (not shown) may be provided in the Baseband chip 220B to coordinately operate with the processor 230 of the Baseband 220A to improve performance.

FIG. 3C shows the hardware architecture of a mobile station 300 according to another embodiment of the invention. The mobile station 300 comprises a single RF module 310, a Baseband chip 320, a dual card controller 340, a display 350 and an input device 360, wherein the two subscriber identity cards A and B may be plugged into two sockets of the mobile station 300 connecting to the dual card controller 340. Those skilled in the art may practice the dual card controller 340 in the Baseband chip 320. One of the subscriber identity cards A and B may be a SIM, USIM, R-UIM or CSIM card, which is provided by a particular network operator. The mobile station 300 can therefore camp on two cells provided by either the same network operator or different network operators for the plugged in cards A and B and operate in stand-by/idle modes, or even dedicated modes, using the same RF module and Baseband chip. The dual card controller 340 is coupled/connected between the Baseband chip 320 and the subscriber identity cards A and B. Furthermore, the Baseband chip 320 comprises a processor 330 for controlling the communications between the subscriber identity cards A and B and the RF module 310, handling MMI usage granting to the subscriber identity cards A and B, handling MMI-related operations (e.g. sending a series of frame data to the display 350, receiving signals from the input device 360, and so on), or others. Moreover, the processor 330 of the Baseband chip 320 may read data from the subscriber identity card A or B via the dual card controller 340, and may also write data to the subscriber identity card A or B via the dual card controller 340.

A RF module (e.g. 110 of FIG. 3A, 210A or 210B of FIG. 3B, or 310 of FIG. 3C) receives wireless radio frequency signals, converts the received signals to baseband signals to be processed by a corresponding Baseband chip (e.g. 120 of FIG. 3A, 220A or 220B of FIG. 3B, or 320 of FIG. 3C), or receives baseband signals from the Baseband chip and converts the received signals to wireless radio frequency signals to be transmitted to a peer device. The RF module may comprise a plurality of hardware devices to perform radio frequency conversion. For example, the RF module may comprise a mixer to multiply the baseband signals with a carrier oscillated in the radio frequency of the wireless communication system, wherein the radio frequency may be, for example, 900 MHz or 1800 MHz for a global system for mobile communication (GSM), or 1900 MHz for a Universal Mobile Telecommunications System (UMTS). The Baseband chip further converts the baseband signals to a plurality of digital signals, and processes the digital signals, and vice versa. The Baseband chip may also comprise a plurality of hardware devices to perform baseband signal processing. The baseband signal processing may comprise analog to digital conversion (ADC)/digital to analog conversion (DAC), gain adjustments, modulation/demodulation, encoding/decoding, and so on.

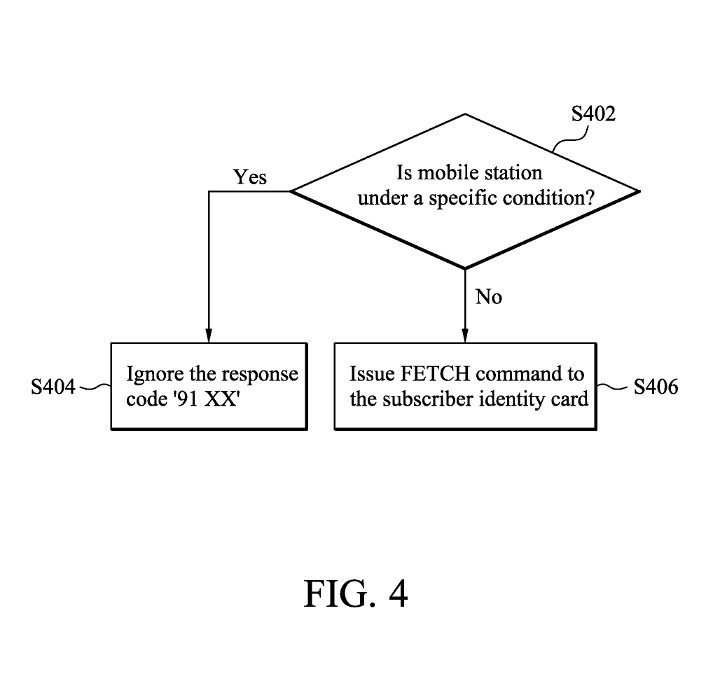

To avoid the mentioned unnecessary interactions, when receiving the response code ‘91 XX’, the processor of Baseband chip (e.g. 130 of FIG. 3A, 230 of FIG. 3B or 330 of FIG. 3C) may perform an embodiment of a method for handling an SAT/USAT application toolkit proactive command request as shown in FIG. 4. First, it is determined whether the mobile station (e.g. 100 of FIG. 3A, 200 of FIG. 3B or 300 of FIG. 3C) is under an extreme/specific condition (step S402), for example, whether the RF module thereof is occupied, battery power thereof is lower than a threshold level, a power on or off procedure of the mobile station is processing, or the mobile station is already in an SAT/USAT session. If so, the response code ‘91 XX’ is ignored (step S404), otherwise, a FETCH command is issued to the subscriber identity card which provides the response code ‘91 XX’ to acquire an SAT/USAT proactive command for further execution (step S406). Ignorance of ‘91 XX’, in other words, may mean that it does not respond to the MCU of subscriber identity card.

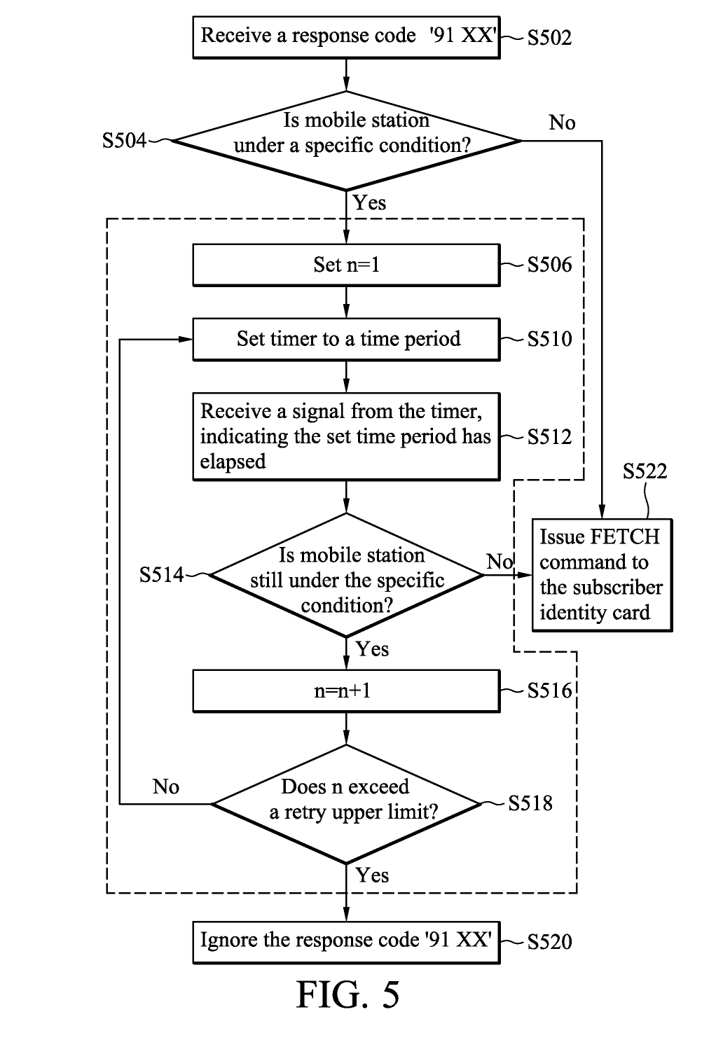

FIG. 5 shows a flow chart illustrating a method for handling an SAT/USAT proactive command request, which is performed when executing software/firmware code by a processor of mobile station (e.g. 130 of FIG. 3A, 230 of FIG. 3B or 330 of FIG. 3C), according to another embodiment of the invention. First, a response code ‘91 XX’ from a subscriber identity card is received (step S502), wherein the response code corresponds to a response data comprising a proactive command for a specific procedure, and the value ‘XX’ indicates the length of the response data. Next, it is determined whether the mobile station is under a specific condition (step S504). As described above, the specific condition is present when the single RF module of the mobile station is occupied, battery power of the mobile station is lower than a threshold level, a power on or off procedure of the mobile station is processing or the mobile station is already in an SAT/USAT session. If so, a retry process containing at least steps S506 to S518 is activated, otherwise, the FETCH command is issued to the subscriber identity card (step S522). In the beginning of the retry process, a variable n indicating a current retry number is set to 1 (step S506) and a loop containing at least steps S510 to S518 is repeatedly performed until the amount of retries exceeds a predetermined retry upper limit or the specific condition is absent. A timer is set to a time period in the beginning of every run of the loop (step S510). When a signal indicating that the set time period has elapsed is received from the timer (step S512), it is determined whether the mobile station is still under the specific condition (step S514). If so (i.e. the specific condition has not ended yet), the variable n is incremented by one (step S516) and another run of the loop is performed when the current retry number does not exceed the predetermined retry upper limit (step S518), otherwise, the FETCH command is issued to the corresponding subscriber identity card (step S522). When the current retry number exceeds the predetermined retry upper limit, the response code ‘91 XX’ will be ignored (step S520). Ignorance of ‘91 XX’, in other words, may mean that it does not respond to the MCU of subscriber identity card.

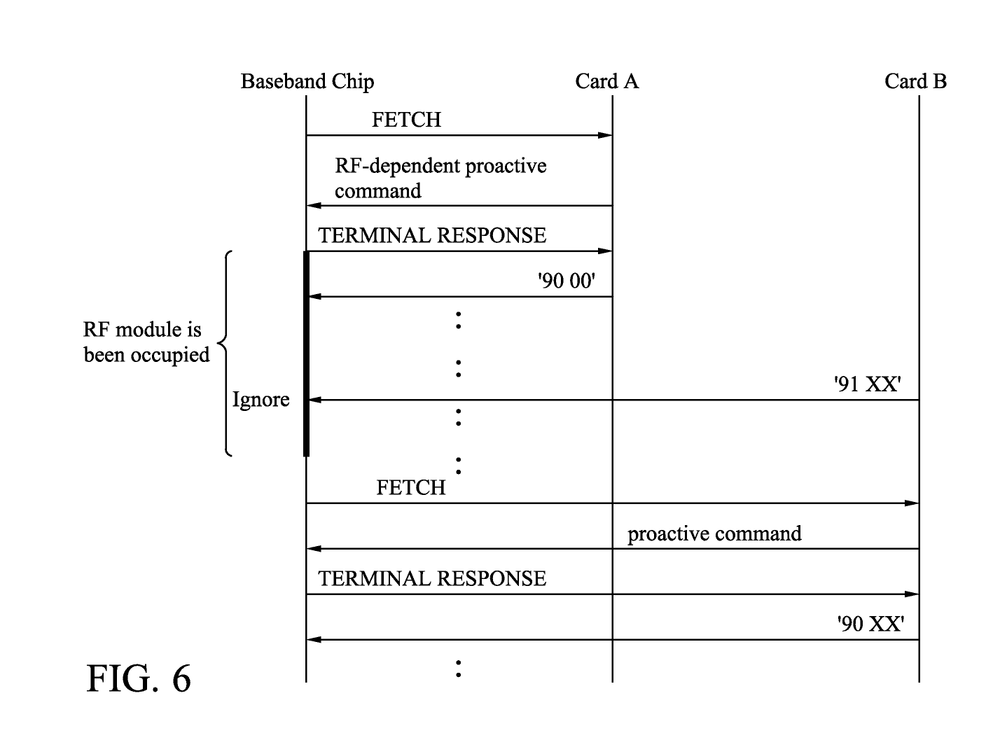

The described embodiments of the method for handling an SAT/USAT proactive command request can be employed in a mobile station equipped with two or more subscriber identity cards sharing a single RF module, such as the mobile station 300 of FIG. 3C. For example, referring to FIG. 6 together with FIG. 3C, the RF module 310 is occupied for the subscriber identity card A when the processor 330 fetches and executes an RF-dependent proactive command from the subscriber identity card A. When the RF module 310 is occupied, the response code ‘91 XX’ from either the subscriber identity card A or B may be ignored. After the RF module 310 is available, the processor 330 fetches and executes any SAT/USAT proactive command from the subscriber identity card B in response to the response code ‘91 XX’ received therefrom.

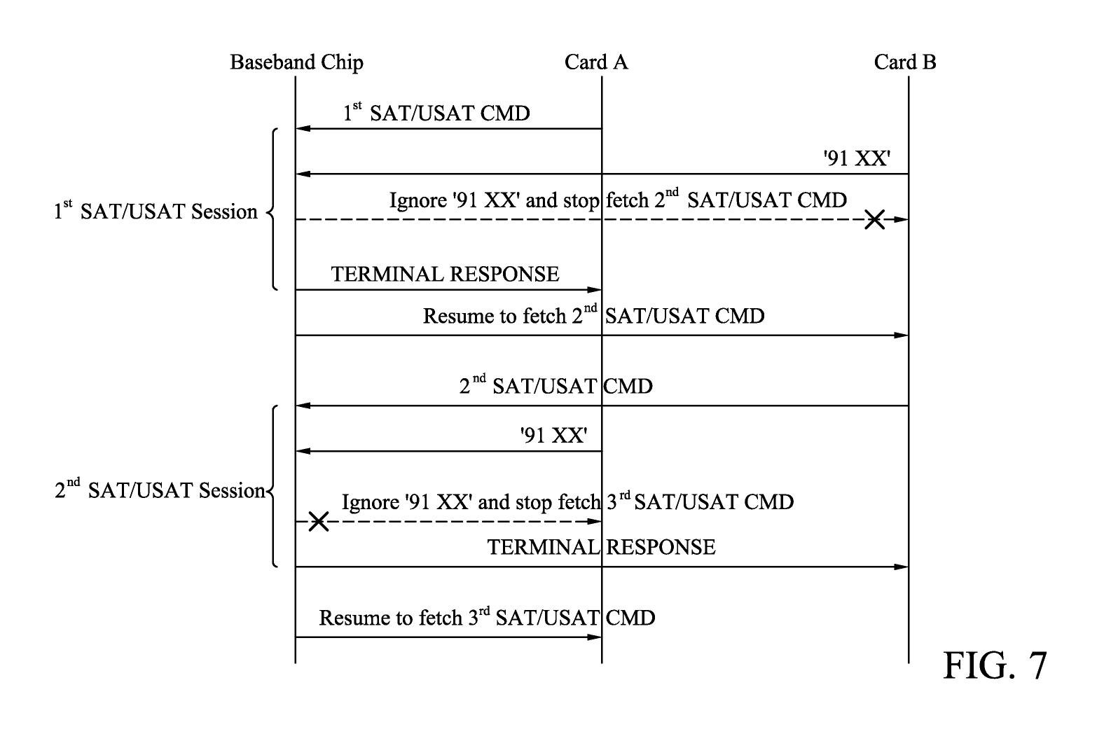

Furthermore, The described embodiments of the method for handling an SAT/USAT proactive command request can be employed in a mobile station equipped with two or more subscriber identity cards, each having a corresponding RF module. For example, referring to FIG. 7 together with FIG. 3B, the MMI is occupied for the subscriber identity card A when the processor 230 fetches and executes a first proactive command therefrom, i.e. the mobile station 200 is in a first SAT/USAT session, in which the processor 230 may send information to the display 240 and requires a response returned from the input device 250. The response code ‘91 XX’ from the subscriber identity card B is ignored during the first SAT/USAT session. When the first SAT/USAT session is completed (such as when the response is received from the input device 250), the processor 230 sends “TERMINAL RESPONSE” to the subscriber identity card A and then resumes to fetch and execute a second proactive command from the subscriber identity card B. Subsequently, the response code ‘91 XX’ from the subscriber identity card A is ignored during a second SAT/USAT session. When the second SAT/USAT session is completed, the processor 230 sends “TERMINAL RESPONSE” to the subscriber identity card B and then resumes to fetch and execute a third proactive command from the subscriber identity card A.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A method for handling a proactive command in a mobile system with a subscriber identity card, executed by a micro-processing unit (MCU) of a Baseband chip, comprising:
receiving a response code from the subscriber identity card, wherein the response code indicates the mobile system to fetch the proactive command for a specific procedure;
determining whether the mobile system is under a specific condition after receiving the response code; and
ignoring the response code until the specific condition is absent.

2. The method as claimed in claim 1, further comprising:
issuing a command to the subscriber identity card to fetch the proactive command when the specific condition is absent, so as to perform the specific procedure according to the proactive command.

3. The method as claimed in claim 2, wherein the step of ignoring the response code comprises:
repeatedly performing a retry process when the mobile system is under the specific condition and retry runs thereof do not exceed a retry upper limit; and
ignoring the response code when the retry runs thereof exceeds the retry upper limit.

4. The method as claimed in claim 3, wherein the step of performing the retry process comprises:
setting a timer to count a time period;
receiving a signal from the timer, wherein the signal indicates that the time period has elapsed;
determining whether the mobile system is under the specific condition after receiving the signal; and
updating a retry number indicating the retry runs thereof when the mobile system is under the specific condition.

5. The method as claimed in claim 4, wherein the step of performing the retry process further comprises:
issuing the command to the subscriber identity card to fetch the proactive command when the specific condition is absent, so as to perform the specific procedure according to the proactive command.

6. The method as claimed in claim 5, wherein the response code is ‘91 XX’ and ‘XX’ represents comprises a length of response data comprising the proactive command.

7. The method as claimed in claim 1, wherein the mobile system is under the specific condition when battery power of the mobile system is lower than a threshold level.

8. The method as claimed in claim 1, wherein the mobile system is under the specific condition when a power on or off procedure of the mobile station is being processed.

9. The method as claimed in claim 1, wherein the mobile system is under the specific condition when a single RF module of the mobile system is utilized to communicate with a network.

10. The method as claimed in claim 1, wherein the mobile system is under the specific condition when a specific procedure corresponding to a previous proactive command is being performed.

11. The method as claimed in claim 1, wherein the mobile system is under the specific condition when a single man-machine interface (MMI) is been occupied.

12. A method for handling a first proactive command and a second proactive command in a mobile system with a first subscriber identity card and a second subscriber identity card, comprising:
receiving a first response code from the first subscriber identity card;
issuing a first command in response to the first response code to the first subscriber identity card to obtain a first proactive command, so as to perform a first procedure according to the first proactive command;
receiving a second response code from the second subscriber identity card; and
not responding to the second response code when the first procedure is not completely preformed.

13. The method as claimed in claim 12, further comprising:
issuing a second command to the second subscriber identity card to obtain a second proactive command after completion of the first procedure, so as to perform a second procedure according to the second proactive command.

14. The method as claimed in claim 13, wherein the step of not responding to the second response code comprises:
repeatedly performing a retry process during the first procedure when retry runs thereof do not exceed a retry upper limit; and
not responding to the second response code when the retry runs thereof exceeds the retry upper limit.

15. The method as claimed in claim 14, wherein the step of performing the retry procedure comprises:
setting a timer to count a time period;
receiving a signal from the timer, wherein the signal indicates that the time period has elapsed; and
updating a retry number indicating the retry runs thereof after receiving the signal.

16. The method as claimed in claim 14, wherein the step of performing the retry procedure further comprises:
issuing a third command to the second subscriber identity card to obtain the second proactive command after detecting completion of the first procedure and the signal is received, so as to perform the second procedure according to the second proactive command.

17. A system, comprising:
a first subscriber identity card; and
a processor receiving a first response code from the first subscriber identity card, the first response code indicating the processor to fetch a first proactive command for performing a first procedure, ignoring the first response code when a specific condition is present, and issuing a first command to the first subscriber identity card to obtain the first proactive command and performing the first procedure according to the first proactive command when the specific condition is absent.

18. The system as claimed in claim 17, further comprising a second subscriber identity card, wherein the processor receives a second response code from the second subscriber identity card and ignores the second response code when the first procedure is not completely preformed.

19. The system as claimed in claim 18, wherein the processor further issues a second command to the second subscriber identity card to obtain a second proactive command after completion of the first procedure, so as to perform a second procedure according to the second proactive command.

20. The system as claimed in claim 19, wherein the processor further repeatedly performs a retry process during the first procedure when retry runs thereof do not exceed a retry upper limit and ignores the second response code when the retry runs thereof exceeds the retry upper limit.
